(19) United States
(12) Patent Application Publication
(10) Pub. No.: US 2007/0010296 A1
(43) Pub. Date: Jan. 11, 2007

(54) Communication system

(76) Inventor: Juan Luis Benitez-Vargas, West Hollywood, CA (US)

Correspondence Address: EMERY L. TRACY, P.O. BOX 1518, BOULDER, CO, 80306, US

(21) Appl. No.: 09/877,641

(22) Filed: Jun. 8, 2001

Related U.S. Application Data
(60) Provisional application No. 60/209,909, filed on Jun. 8, 2000.

(51) Int. Cl. H04M 1/00

(52) U.S. Cl. 455/575.2; 455/569.1

(57) ABSTRACT

A new and improved system is disclosed designed for allowing a user to use a cell phone while driving wireless and without loudspeakers, and at the same time, have both hands free to operate a vehicle or perform other important tasks that a user would be performing. The present invention would comprise a universal plug and a cordless ear-talk attachment with a maximum range of ten feet from ear to phone. The universal plug would plug into any cell phone. The ear-talk attachment that would come with a particular universal plug would include a earset, one ear phone with included volume control, one microphone, and one integral receptor/transmitter mechanism. In use, a user, after making a call with the cell phone, would be able to place the cell phone to hear and talk with a person through their cell phone by using the included ear-talk attachment in a private manner without loudspeakers and undesired surrounding noise intereference.

### BACKGROUND OF THE INVENTION

The present invention concerns that of a new and improved system designed to allow a user to use a cell phone while driving or performing other important tasks, and at the same time, have both hands free to operate a vehicle or perform other important tasks that a user would be performing.

### DESCRIPTION OF THE PRIOR ART

U.S. Pat. No. 5,839,086, issued to Hirano, discloses

### SUMMARY OF THE INVENTION

The present invention concerns that of a new and improved system designed to allow a user to use a cordless cell phone while driving or performing other important tasks, and at the same time, have both hands free to operate a vehicle or perform other important tasks that a user would be performing. The present invention would comprise a universal plug and a cordless ear-talk attachment with a maximum range of ten feet from ear to phone. The universal plug would plug into any cell phone. The ear-talk attachment that would come with a particular universal plug would include a earset, one ear phone with volume control for amplification, one microphone, and one integral receptor/transmitter mechanism. In use, a user, after making a call with the cell phone, would be able to place the cell phone to hear and talk privately without loudspeakers with a person through their cell phone by using the included ear-talk wireless attachment.

El There has thus been outlined, rather broadly, the more important features of a hands-free cordless communication system in order that the detailed description thereof that follows may be better understood and in order that the present contribution to the art may be better appreciated. There are, of course, additional features of the hands-free cordless communication system that will be described hereinafter and which will form the subject matter of the claims appended hereto.

In this respect, before explaining at least one embodiment of the hands-free wireless communication system in detail, it is to be understood that the hands-free communication system is not limited in its application to the details of construction and to the arrangements of the components set forth in the following description or illustrated in the drawings. The hands-free cordless communication system is capable of other embodiments and being practiced and carried out in various ways. Also, it is to be understood that the phraseology and terminology employed herein are for the purpose of descriptions and should not be regarded as limiting.

As such, those skilled in the art will appreciate that the conception, upon which this disclosure is based, may readily be utilized as a basis for the designing of other structures, methods and systems for carrying out the several purposes of the present hands-free wireless communication system. It is important, therefore, that the claims be regarded as including such equivalent constructions insofar as they do not depart from the spirit and scope of the present invention.

It is therefore an object of the present invention to provide a hands-free wireless communication system which has all of the advantages of the prior art and none of the disadvantages.

It is another object of the present invention to provide a hands-free wireless communication system which may be easily and efficiently manufactured and marketed.

It is another object of the present invention to provide a hands-free wireless communication system which is of durable and reliable construction.

It is yet another object of the present invention to provide a hands-free wireless communication system which is economically affordable and available for relevant purchasing government entities.

Other objects, features and advantages of the present invention will become more readily apparent from the following detailed description of the preferred embodiment when considered with the attached drawings and appended claims.

### BRIEF DESCRIPTION OF THE DRAWINGS

FIG. 1 shows a top view of the universal plug attached to a cell phone.

FIG. 2 shows a perspective view of the ear-talk wireless attachment of the present invention.

### DESCRIPTION OF THE PREFERRED EMBODIMENT

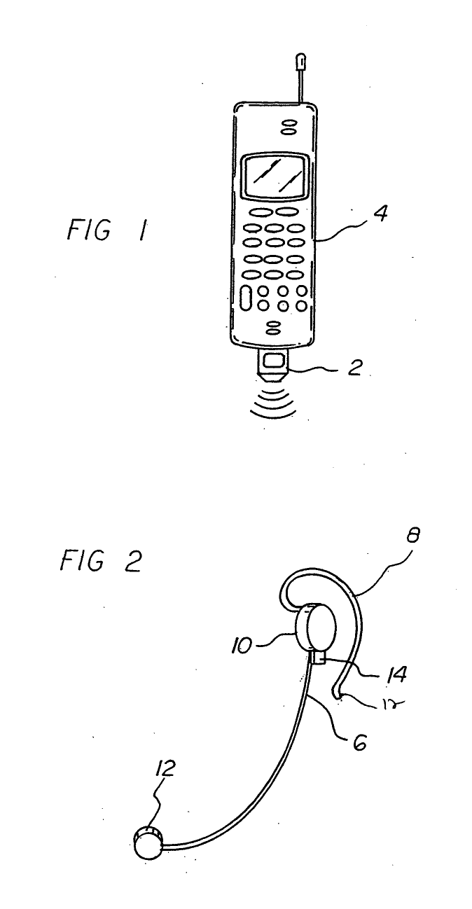

FIG. 1 shows a top view of universal plug 2 attached to a cell phone 4. Universal plug 2 would be capable of transmitting private conversations without loudspeakers over a particular cell phone to ear-talk attachment 6 after a user has called up a person with cell phone 4.

FIG. 2 shows a perspective view of ear-talk attachment 6 of the present invention. Ear-talk attachment 2 would comprise an ear hanger 8, ear phone 10, microphone 12, and integral receptor/transmitter 14. Ear hanger 8 would be designed to wrap around the top of a user's head and would have two ends, a first end and a second end. The ear phone 10 would include an ADA volume control and would be connected to the first end of ear hanger 8, would overlap a single ear of a user and would be used to hear words or sounds spoken by the other party or parties in a telephone conversation. Microphone 12 would be attached to the second end of ear hanger 8, with microphone 12 located directly in front of a user's mouth. Microphone 12 would pick up any sounds made by a user and would function the same as in a standard telephone. Integral receptor/transmitter 14 would receive signals from and transmit signals to universal plug 2 in cell phone 4. The ADA volume control would be present for use due to Title VII of the Americans With Disabilities Act of 1992, with include telecommunications requirements for the hard of hearing.

In use, a user, after making a call with cell phone 4, would be able to place cell phone 4 down and talk with and hear a person through cell phone 4 by using ear-talk wireless attachment 6. The present invention would allow a user to use cell phone 4 while driving or performing other important tasks, and at the same time, have both hands free to operate a vehicle or perform other important tasks that a user would be performing. The present invention would preferably be used with cellular phones using PCS or RCP technology.

What I claim as my invention is:

1. A system for hands-free wireless cellular phone use comprising:
(a) an earset including a ear hanger, an earphone with volume control, a microphone, and a receptor/transmitter unit capable of receiving and transmitting signals of a specific wavelength, the receptor/transmitter unit electronically connected to the earphone and microphone, the earset designed to be worn over a user's ear, the earphone designed to be positioned over an ear of a user, the microphone designed to be positioned over a user's mouth,
(b) a cellular phone,
(c) a universal plug electronically connected to the cellular phone, the universal plug capable of receiving and transmitting signals of a specific wavelength,
(d) wherein a user would be able to use the earset to communicate with another individual through the cellular phone.

2. A system for hands-free wireless cellular phone according to claim 1 wherein the receptor/transmitter unit and the universal plug would be capable of using the same wavelength.

3. A system for hands-free wireless cellular phone according to claim 2 wherein words spoken into the microphone of the earset are converted to radio signals of a specific wavelength, wherein the signals are then transmitted and amplified by the receptor/transmitter unit in the earset to the universal plug, wherein the universal plug then converts the radio signals transmitted from the receptor/transmitter unit into audible amplified communication, allowing communication to the another individual who would in telephonic communication with a person using the present invention.

4. A system for hands-free wireless cellular phone according to claim 2 wherein words spoken by another individual who would in telephonic communication with a person using the present invention would be converted into radio signals of a specific wavelength by the universal plug, wherein the signals are then transmitted by the universal plug unit attached to the cellular phone to the receptor/transmitter unit in the earset, wherein the receptor/transmitter unit then converts the radio signals received from the receptor/transmitter unit into audible amplified communication, allowing communication originated from another individual to reach a person using the present invention.
